(19) United States
(12) Patent Application Publication
(10) Pub. No.: US 2007/0166676 A1
(43) Pub. Date: Jul. 19, 2007

(54) COGNITIVE TRAINING USING GUIDED EYE MOVEMENTS

(75) Inventors: Dylan Bird, San Francisco, CA (US); Samuel C. Chan, Alameda, CA (US); Peter B. Delahunt, San Mateo, CA (US); Joseph L. Hardy, Richmond, CA (US); Stephen G. Lisberger, San Francisco, CA (US); Henry W. Mahncke, San Francisco, CA (US); Michael M. Merzenich, San Francisco, CA (US)

Correspondence Address: HUFFMAN LAW GROUP, P.C., 1900 MESA AVE., COLORADO SPRINGS, CO, 80906, US

(73) Assignee: POSIT SCIENCE CORPORATION, San Francisco, CA (US)

(21) Appl. No.: 11/611,329

(22) Filed: Dec. 15, 2006

Related U.S. Application Data
(60) Provisional application No. 60/750,509, filed on Dec. 15, 2005.
(60) Provisional application No. 60/821,935, filed on Aug. 9, 2006.
(60) Provisional application No. 60/822,537, filed on Aug. 16, 2006.

(51) Int. Cl. G09B 19/00

(52) U.S. Cl. 434/236

(57) ABSTRACT

Computer-implemented method for enhancing cognitive ability of a participant using guided eye movements. Multiple graphical elements are provided for visual presentation to the participant, each having a value. A temporal sequence of at least two of the graphical elements are visually presented at a specified stimulus intensity, e.g., duration or presentation time, including displaying the value of each graphical element at a respective position in a visual field for a specified duration, then ceasing to display the value. The participant is required to respond to the displayed values. A determination is made as to whether the participant responded correctly, and the stimulus intensity modified in response, e.g., using a maximum likelihood procedure. The visually presenting, requiring, determining, and modifying are repeated in an iterative manner to improve the participant's cognitive skills. Periodically, assessments of the participant's progress are performed, e.g., using the maximum likelihood procedure.

### CROSS REFERENCE TO RELATED APPLICATION(S)

This application claims the benefit of the following U.S. Provisional Patent Applications, which are incorporated herein in their entirety for all purposes:

| Docket | | Filing | |
|---|---|---|---|
| No. | Serial No. | Date: | Title: |
| PS.0119 | 60/750509 | Dec. 15, 2005 | HAWKEYE ASSESSMENTS |
| | | | SPECIFICATION |
| PS.0221 | 60/821935 | Aug. 9, 2006 | COMPUTER BASED TRAINING |
| | | | PROGRAM TO REVERSE AGE |
| | | | RELATED DECLINES IN EYE- |
| | | | MOVEMENT EFFICIENCY |
| PS.0224 | 60/822537 | Aug. 16, 2006 | COMPUTER BASED TRAINING |
| | | | PROGRAM TO REVERSE AGE |
| | | | RELATED DECLINES IN EYE- |
| | | | MOVEMENT EFFICIENCY |

The following applications are related to the present application:

| | | | |
|---|---|---|---|
| PS.0217 | ******* | ******* | COGNITIVE TRAINING USING |
| | | | VISUAL SWEEPS |
| PS.0218 | ******* | ******* | COGNITIVE TRAINING USING |
| | | | VISUAL SEARCHES |
| PS.0219 | ******* | ******* | COGNITIVE TRAINING USING |
| | | | MULTIPLE OBJECT TRACKING |
| PS.0220 | ******* | ******* | COGNITIVE TRAINING USING |
| | | | FACE-NAME ASSOCIATIONS |
| PS.0229 | ******* | ******* | COGNITIVE TRAINING USING |
| | | | VISUAL STIMULI |
| PS.0230 | ******* | ******* | VISUAL EMPHASIS FOR |
| | | | COGNITIVE TRAINING |

### Field of the Invention

This invention relates in general to the use of brain health programs utilizing brain plasticity to enhance human performance and correct neurological disorders, and more specifically, to a method for improving the ability of the visual nervous system to perform eye movements efficiently, and to improve cognition.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

Many daily tasks require extraction of visual information from a scene quickly and accurately. Avoiding dangers when driving a car, scanning a crowd for a familiar face, and reading quickly are a few examples of situations where visual information must be extracted quickly to perform well. Searching a scene involves two main processes. First, eyes make saccades—very rapid movements from one object to another. Second, the brain quickly captures information from each eye fixation so that the next saccade can be made. Efficient eye-movements and information processing are important for rapidly obtaining information from a scene.

As people get older, the frequency of rapid fixation eye-movements (“saccades”) declines, as does their accuracy. In addition, the time required to extract relevant information from the visual scene during each fixation (between saccades) increases. As a result, the ability to extract information quickly and accurately from a visual scene declines. In daily life, tasks that had been easy—like scanning a newspaper article for important details—get harder. This is important for tasks such as driving and crossing the road, as well as for reading speed and accuracy.

In many older adults, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The development of novel therapies to prevent the onset of this devastating neurological disorder is a key goal for modem medical science.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years, which only now through the application of computer technology can be brought out of the laboratory and into the everyday therapeutic treatment.

Thus, improved systems and methods for improving the ability of the visual nervous system of a participant to perform eye movements efficiently, and to improve cognition.

### SUMMARY

Various embodiments of a system and method are presented for performing a computer-based exercise to renormalize and improve the ability of the visual nervous system of a participant to perform eye movements efficiently, and to improve cognition. More specifically, the exercise may operate to improve the efficiency of saccades and decrease the time it takes to extract accurate information from a scene.

In embodiments of this exercise, the participant is required to move his or her gaze rapidly to a series of targets presented on the monitor in a specific order, and obtain information from each target fixation. The participant then responds to this information, where the type of response required depends upon the particular version of the exercise. Note that the information contained in each stimulus should be small enough to require the participant to move their fixation to the target to process it.

It should be noted that various embodiments of the Eye Movement exercise described herein, and/or other eye movement tasks, may be used singly or in combination in the exercise. Moreover, as described below, in some embodiments, stimulus threshold assessments may also be performed in conjunction with, or as part of, the exercise, thus facilitating more effective training of the participant's cognitive systems, e.g., memory and visual processing systems.

First, multiple graphical elements may be provided, where each graphical element has a value, and where the multiple graphical elements are available for visual presentation to the participant. In other words, a set of images may be provided where each image has or is associated with a respective value. For example, as will be discussed below in detail, examples of such graphical elements include, but are not limited to, images of numbers, playing cards, and letter tiles, among others.

Next, a temporal sequence of at least two of the graphical elements may be visually presented at a specified stimulus intensity, including displaying the value of each of the at least two graphical elements at a respective position in a visual field for a specified duration, then ceasing to display the value. Said another way, a series of two or more graphical elements (from the multiple graphical elements) may be displayed in sequence at a specified stimulus intensity, where each of the graphical elements is displayed at a respective location in the visual field, e.g., in a display area of a graphical user interface (GUI). The value of each graphical element may be displayed (at its respective position) for a specified period of time, i.e., a duration, then the respective value is removed from view, e.g., hidden, not displayed, etc. Note that in various embodiments, the displayed values of the graphical elements may be any of a variety of values, such as, for example, numbers, letters, colors, and/or shapes, among others. In one embodiment, visually presenting the temporal sequence of at least two of the graphical elements includes visually presenting the at least two graphical elements at a specified stimulus intensity. Note that as used herein, the term stimulus intensity refers to any adjustable stimulus attribute or adaptive dimension that may be modified to increase or decrease the difficulty of a task. For example, in some embodiments, the stimulus intensity may be the presentation time or duration of each value, and/or the inter-stimulus interval. In some embodiments, the duration of the display of each value and the duration of the inter-stimulus interval (ISI) may together form the stimulus intensity, and may be referred to as the duration of the stimulus. In other words, in various embodiments, the duration may refer to the duration of the display of the values and/or the ISI. Thus, the stimulus intensity may be compound or complex.

It should be noted that while in preferred embodiments, the stimulus intensity may be or include the duration, in other embodiments, the stimulus intensity may include one or more of: the eccentricity of the respective positions of the least two graphical elements in the visual field, the number of graphical elements in the temporal sequence, and/or the appearance or visual emphasis of the graphical elements, e.g., the size, contrast, color, homogeneity, etc., of the graphical elements in the visual field, among others. In other words, the stimulus intensity may refer to any adjustable attribute of the stimulus and/or its presentation that may be modified to increase or decrease the difficulty of trials in the exercise.

In preferred embodiments, the participant may perform the exercise via a graphical user interface (GUI). The GUI may include a visual field or display area, e.g., a stimulus presentation area where the sequences of graphical elements of may be presented to the participant. In some embodiments, the visual field may include a fixation point, which may be displayed in the center of the visual field. The fixation point may serve as a reference point in the visual field for positioning graphical elements, and/or as a neutral point for the participant's gaze, e.g., before the sequence is presented. Note that in some embodiments, the fixation point may not be displayed.

Note that each value is displayed in a respective position in the visual field such that to view or examine each graphical element (number) in the sequence, the participant must move his or eyes across the visual field. In other words, to perceive the values presented, the participant may be required to perform saccades, quickly moving the eyes to focus at each position.

In some embodiments, the respective positions of the at least two graphical elements may be determined randomly. For example, the first graphical element of the at least two graphical elements may have a first position (randomly determined) with a first azimuth, and each subsequent graphical element of the at least two graphical elements may have an azimuth differing from that of the previous graphical element by a respective angle. In other words, the position of the first graphical element in the presented sequence may be randomly chosen or selected, possibly subject to one or more constraints, e.g., range constraints, as will be discussed below. This first position has an azimuthal angle with respect to some reference vector, e.g., a vector from the center fixation point straight up to the center of the top edge of the visual field. Each succeeding graphical element/value may be positioned by randomly determining a distance from the fixation point (again, possibly subject to one or more constraints), and randomly determining respective angle, i.e., an angular offset, from the azimuth of the first graphical element.

In one embodiment, the values of the sequenced graphical elements may be displayed in respective “patches” or local backgrounds, e.g., to aid or hinder the participant's perception of the values. For example, in one embodiment, each value may be displayed in a respective Gabor patch in the visual field, where, as used herein, a Gabor patch refers to a windowed sine-wave modulated grating or pattern that varies in luminance (roughly equivalent to the phenomenal experience of lightness) as a sine function of space along a particular direction or orientation, e.g., windowed by a 2-dimensional Gaussian to remove sharp edges which otherwise introduce high spatial frequency intrusions. Each Gabor patch may have a respective orientation, where, after a first displayed value of the at least two graphical elements, each Gabor patch orientation may be rotated a specified amount with respect to an immediately previous Gabor patch. In other embodiments, other background patches may be used as desired.

The participant may then be required to respond to the displayed values. For example, in an embodiment where a series of numbers are presented in temporal sequence, the participant may be required to input or otherwise indicate the numeric sequence, e.g., via a keyboard coupled to the computing device, although any other means may be used as desired. In other words, requiring the participant to respond to the displayed values may include requiring the participant to indicate the sequence of the displayed values. As will be described in detail below, other embodiments of the exercise may use other types of graphical elements (besides simple numbers), and may require correspondingly different responses from the participant.

A determination may be made as to whether the participant responded correctly. For example, following the above-described embodiment, a determination may be made as to whether the participant correctly indicated the numeric sequence. In preferred embodiments, the method may include audibly and/or graphically indicating whether the participant responded correctly. In embodiments where the participant's response includes a plurality of selections, indicating whether the participant responded correctly may include indicating whether the participant's selection is correct for each selection, e.g., for each selection, an indicative sound, such as a “ding” or “thunk” (and/or a graphical indication) may be played indicating whether that selection were correct or incorrect, respectively. In some embodiments, points may be awarded (in the case of a correct response and/or selection). Of course, any other type of indication may be used as desired. For example, in embodiment where a trial includes multiple selections, a first sound, e.g., a wind sound, may be played when the participant makes a correct selection, and a second sound, e.g., a chime sound, may be played when the participant has made all selections in the trial correctly.

In some embodiments, each response of the participant may be recorded. Similarly, in some embodiments, the method may include recording whether the participant responded correctly. For example, the responses and/or their correctness/incorrectness may be stored in a memory medium of the computing device, or coupled to the computing device.

The stimulus intensity, e.g., duration, may then be modified based on the above determining. Of course, as mentioned above, the stimulus intensity may be any adjustable attribute of the graphical elements and/or their presentation, and so modifying the stimulus intensity may include modifying any of these adjustable attributes as desired. Modifying the stimulus intensity based on said determining preferably includes adjusting the stimulus intensity for the visually presenting based on whether the participant responded correctly. In one embodiment, the adjusting may be performed using a maximum likelihood procedure, such as, for example, a QUEST (quick estimation by sequential testing) threshold procedure, and/or a ZEST (zippy estimation by sequential testing) threshold procedure, e.g., a single-stair maximum likelihood procedure.

In one embodiment, adjusting the stimulus intensity may include decreasing the duration if the participant responds correctly, and increasing the duration if the participant responds incorrectly, although other attributes may be adjusted as desired. Thus, for example, in one embodiment, the duration may be set initially at 500 ms, and may adapt based on performance. In one modification scheme, after a correct response the duration may be multiplied by 0.8, and after an incorrect response, divided by 0.8. The inter-stimulus interval may be fixed at 200 ms for every trial. In some embodiments, the duration may have minimum and maximum values, e.g., a minimum of 40 ms, and a maximum of 1000 ms. Of course, other modification schemes (and other ISI values) may be used as desired.

The visually presenting, requiring, determining, and modifying may be repeated one or more times in an iterative manner to improve the participant's cognitive skills. For example, the repetitions may be performed over a plurality of sessions, e.g., over days, weeks, or even months, e.g., for a specified number of times per day, and for a specified number of days.

The above described visually presenting, requiring, determining, and modifying may compose performing a trial in the exercise. In preferred embodiments, the repeating may include performing a plurality of trials under each of a plurality of conditions, where each condition specifies one or more attributes of the at least two graphical elements or their presentation.

In some embodiments, over the course of performing the plurality of trials, the stimulus intensity may be adjusted to approach and substantially maintain a specified success rate for the participant. For example, the stimulus intensity may be adjusted to approach and substantially maintain a specified success rate for the participant uses a single stair maximum likelihood procedure. Moreover, in further embodiments, the adjusting the stimulus intensity to approach and substantially maintain a specified success rate for the participant may be performed for each of the plurality of conditions.

In some embodiments, during the performance of the exercise, assessments may be made periodically, e.g., using a maximum likelihood procedure, e.g., a 2-stair maximum likelihood procedure, e.g., a 2-stair ZEST procedure, to determine or characterize the participant's progress in performing the exercise.

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a high-level flowchart of one embodiment of a method for cognitive training using eye movement, according to one embodiment;

FIG. 4 illustrates an exemplary screenshot of a simple GUI with a fixation point, according to one embodiment;

FIGS. 5-8 illustrate exemplary successive screenshots of a presented numeric sequence in an Eye Movement exercise, according to one embodiment;

FIG. 9 illustrates an exemplary screenshot of the participant's response to the numeric sequence of FIGS. 5-8, according to one embodiment;

FIGS. 10 and 11 illustrate exemplary screenshots of a GUI for an Eye Movement exercise using playing cards in close and wider spatial arrangements, respectively, according to one embodiment;

FIGS. 12 and 13 illustrate exemplary screenshots of the GUI of FIGS. 10 and 11, displaying sequenced playing cards and cards with which to match them, according to one embodiment;

FIG. 14 illustrates an exemplary score and bonus indicator, according to one embodiment;

FIG. 15 illustrates an exemplary screenshot of a GUI instructing the participant to proceed to the next level in the Eye Movement exercise, according to one embodiment;

FIG. 16 illustrates an exemplary screenshot of a trial initiating screen in a GUI for an Eye Movement exercise using a grid of letter tiles, according to one embodiment;

FIG. 17 illustrates an exemplary screenshot of the Eye Movement exercise GUI with letter tiles illustrating presentation of a letter sequence, according to one embodiment;

FIG. 18 illustrates an exemplary screenshot of the Eye Movement exercise GUI with letter tiles illustrating the participant's response to the letter sequence, according to one embodiment;

FIGS. 19 and 20 illustrate exemplary screenshots of a GUI for an Eye Movement exercise using letter tiles in close and wider spatial arrangements, respectively, according to one embodiment;

FIG. 21 illustrates convergence to a threshold value over a series of trials in an exemplary two-stair ZEST threshold procedure.

### DETAILED DESCRIPTION

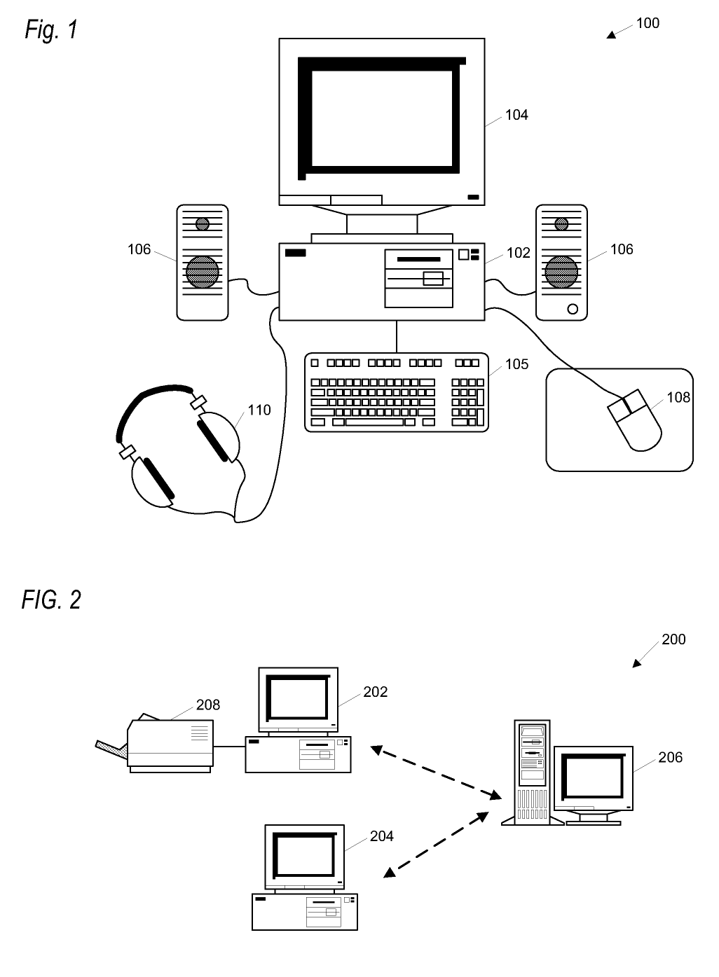

Referring to FIG. 1, a computer system 100 is shown for executing a computer program to train, or retrain an individual according to the present invention to enhance cognition, where the term “cognition” refers to the speed, accuracy and reliability of processing of information, and attention and memory, and where the term “attention” refers to the facilitation of a target and/or suppression of a non-target over a given spatial extent, object-specific area or time window. The computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. In some embodiments, the speakers 106 and the headphones 110 may provide auditory prompting and feedback to the subject during execution of the computer program. The mouse 108 allows the subject to navigate through the computer program, and to select particular responses after visual or auditory prompting by the computer program. The keyboard 105 allows an instructor to enter alphanumeric information about the subject into the computer 102. Although a number of different computer platforms are applicable to the present invention, embodiments of the present invention execute on either IBM compatible computers or Macintosh computers, or similarly configured computing devices such as set top boxes, PDA's, gaming consoles, etc.

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can review the information and can then download configuration and control information pertaining to a particular subject, back to the subject's computer 202, 204.

Overview of the Eye Movement Exercise

Embodiments of the computer-based exercise described herein may operate to renormalize and improve the ability of the visual nervous system of a participant to perform eye movements efficiently, and to improve cognition. More specifically, the exercise may operate to improve the efficiency of saccades and decrease the time it takes to extract accurate information from a scene.

In embodiments of this exercise, the participant is required to move his or her gaze rapidly to a series of targets presented on the monitor in a specific order, and obtain information from each target fixation. The participant then responds to this information, where the type of response required depends upon the particular version of the exercise. Note that the information contained in each stimulus should be small enough to require the participant to move their fixation to the target to process it.

It should be noted that various embodiments of the Eye Movement exercise described herein, and/or other eye movement tasks, may be used singly or in combination in the exercise. Moreover, as described below, in some embodiments, stimulus threshold assessments may also be performed in conjunction with, or as part of, the exercise, thus facilitating more effective training of the participant's cognitive systems, e.g., memory and visual processing systems.

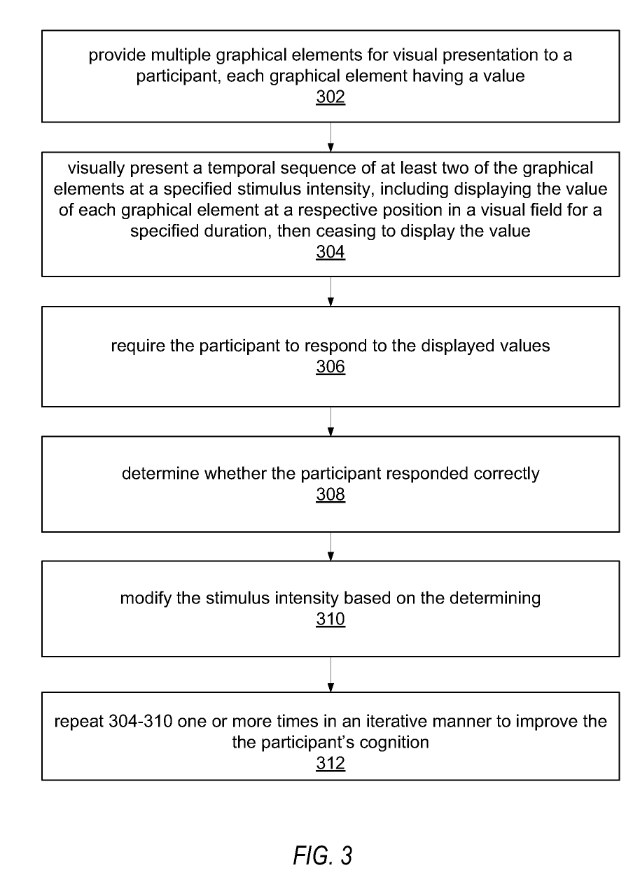

FIG. 3—Flowchart of a Method for Cognitive Training Using Eye Movement

FIG. 3 is a high-level flowchart of one embodiment of a method for cognitive training using eye movement. More specifically, the method utilizes a computing device to present a plurality of images, including a target image and a plurality of distracter images, from which the participant is to select the target image, and to record responses from the participant. It should be noted that in various embodiments, some of the method elements may be performed concurrently, in a different order than shown, or may be omitted. Additional method elements may also be performed as desired. As shown, the method may be performed as follows:

In 302, multiple graphical elements may be provided, where each graphical element has a value, and where the multiple graphical elements are available for visual presentation to the participant. In other words, a set of images may be provided where each image has or is associated with a respective value. For example, as will be discussed below in detail, examples of such graphical elements include, but are not limited to, images of numbers, playing cards, and letter tiles, among others.

In 304, a temporal sequence of at least two of the graphical elements may be visually presented at a specified stimulus intensity, including displaying the value of each of the at least two graphical elements at a respective position in a visual field for a specified duration, then ceasing to display the value. Said another way, a series of two or more graphical elements (from the multiple graphical elements of 302) may be displayed in sequence at a specified stimulus intensity, where each of the graphical elements is displayed at a respective location in the visual field, e.g., in a display area of a graphical user interface (GUI). The value of each graphical element may be displayed (at its respective position) for a specified period of time, i.e., a duration, then the respective value is removed from view, e.g., hidden, not displayed, etc. Note that in various embodiments, the displayed values of the graphical elements may be any of a variety of values, such as, for example, numbers, letters, colors, and/or shapes, among others.

As used herein, the term stimulus intensity refers to any adjustable stimulus attribute or adaptive dimension that may be modified to increase or decrease the difficulty of a task. For example, in some embodiments, the stimulus intensity may be the presentation time or duration of each value, and/or the inter-stimulus interval. In some embodiments, the duration of the display of each value and the duration of the inter-stimulus interval (ISI) may together form the stimulus intensity, and may be referred to as the duration of the stimulus. In other words, in various embodiments, the duration may refer to the duration of the display of the values and/or the ISI. Thus, the stimulus intensity may be compound or complex.

It should be noted that while in preferred embodiments, the stimulus intensity may be or include the duration, in other embodiments, the stimulus intensity may include one or more of: the eccentricity of the respective positions of the least two graphical elements in the visual field, the number of graphical elements in the temporal sequence, and/or the appearance or visual emphasis of the graphical elements, e.g., the size, contrast, color, homogeneity, etc., of the graphical elements in the visual field, among others. In other words, the stimulus intensity may refer to any adjustable attribute of the stimulus and/or its presentation that may be modified to increase or decrease the difficulty of trials in the exercise.

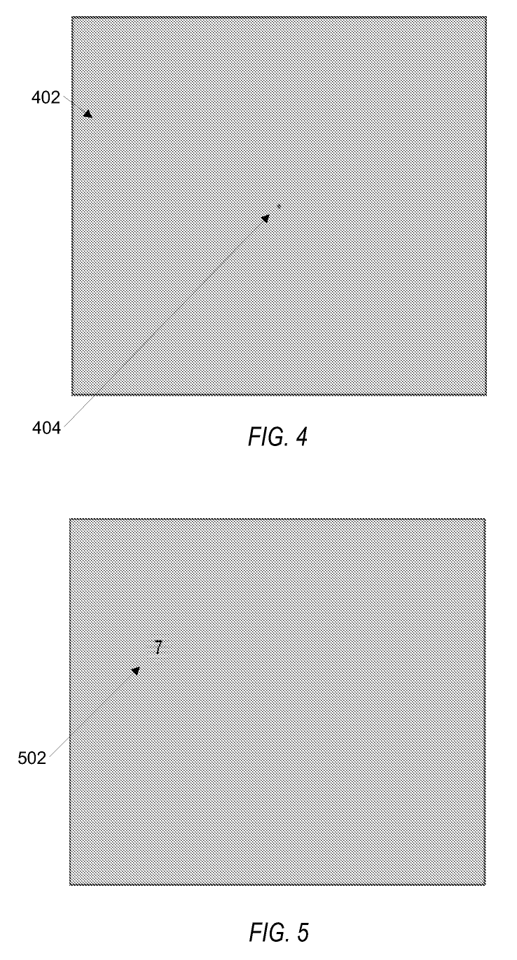

As indicated above, in preferred embodiments, the participant may perform the exercise via a graphical user interface (GUI). FIG. 4 is an exemplary screenshot of a simple GUI suitable for some embodiments of the exercise described herein. As FIG. 4 shows, the GUI may include a visual field or display area 402, e.g., a stimulus presentation area where the sequences of graphical elements of may be presented to the participant. As FIG. 4 also shows, in some embodiments, the visual field may include a fixation point 404, which in this case is displayed in the center of the visual field 402. The fixation point may serve as a reference point in the visual field for positioning graphical elements, and/or as a neutral point for the participant's gaze, e.g., before the sequence is presented. Note that in some embodiments, the fixation point may not be displayed.

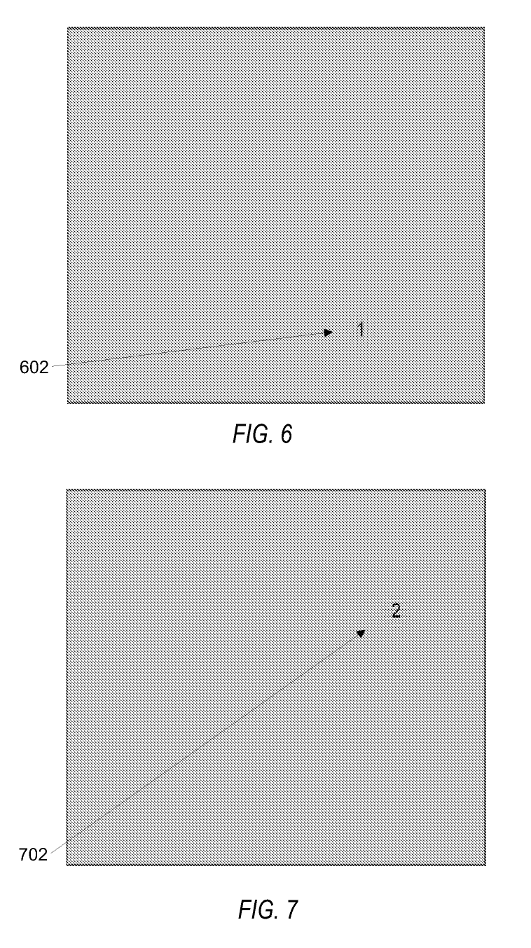

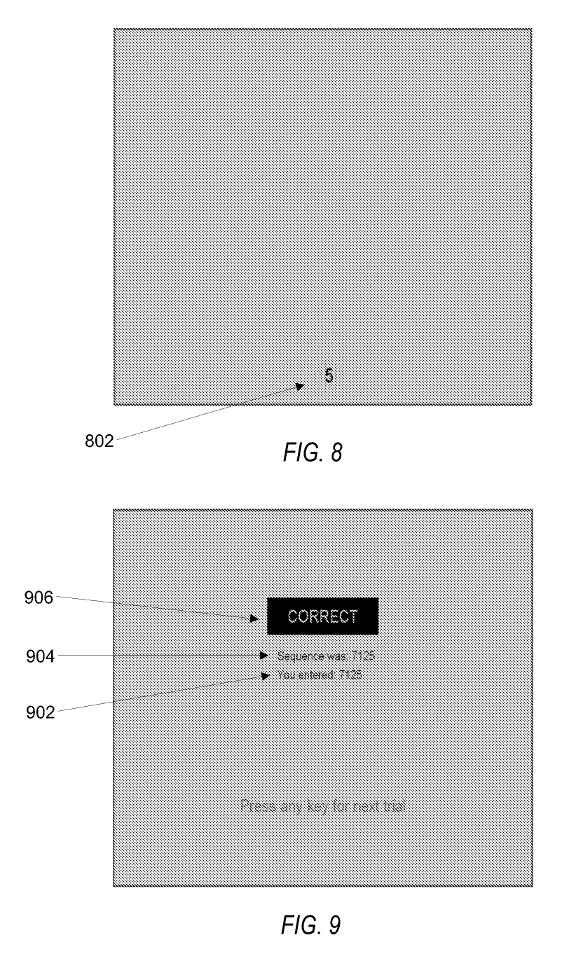

FIGS. 5-8 are exemplary successive screenshots of the GUI of FIG. 4, wherein a sequence of numbers are respectively displayed (at respective positions). More specifically, FIG. 5 illustrates the visual presentation of the number seven 502, FIG. 6 illustrates the visual presentation of the number one 602, FIG. 7 illustrates the visual presentation of the number two 702, and FIG. 8 illustrates the visual presentation of the number five 802. Note that each number is displayed in a respective position in the visual field such that to view or examine each graphical element (number) in the sequence, the participant must move his or eyes across the visual field. In other words, to perceive the values presented, the participant may be required to perform saccades, quickly moving the eyes to focus at each position.

In some embodiments, the respective positions of the at least two graphical elements may be determined randomly. For example, the first graphical element of the at least two graphical elements may have a first position (randomly determined) with a first azimuth, and each subsequent graphical element of the at least two graphical elements may have an azimuth differing from that of the previous graphical element by a respective angle. In other words, the position of the first graphical element in the presented sequence may be randomly chosen or selected, possibly subject to one or more constraints, e.g., range constraints, as will be discussed below. This first position has an azimuthal angle with respect to some reference vector, e.g., a vector from the center fixation point straight up to the center of the top edge of the visual field. For example, referring back to FIG. 5, the displayed “7” has an azimuth of approximately −70 degrees, e.g., ˜70 degrees counter-clockwise from “12 o'clock”. Each succeeding graphical element/value may be positioned by randomly determining a distance from the fixation point (again, possibly subject to one or more constraints), and randomly determining respective angle, i.e., an angular offset, from the azimuth of the first graphical element.

For example, in one embodiment, the respective angle is a randomly determined angle between approximately 90 and approximately 180 degrees, or between approximately −90 and approximately −180 degrees. Mathematically expressed, the angle may be +/−(90+random(90)) degrees. A primary purpose of the different positions of the graphical elements is to force the participant to move his or her eyes substantially to focus on each graphical element. Of course, other schemes for distributing the graphical elements in the visual field may be used as desired. For example, in some embodiments, one or more low discrepancy sequences may be used to select or determine positions of the graphical elements in the visual field.

In one embodiment, the values of the sequenced graphical elements may be displayed in respective “patches” or local backgrounds, e.g., to aid or hinder the participant's perception of the values. For example, as illustrated in FIGS. 5-8, in one embodiment, each value may be displayed in a respective Gabor patch in the visual field, where, as used herein, a Gabor patch refers to a windowed sinewave modulated grating or pattern that varies in luminance (roughly equivalent to the phenomenal experience of lightness) as a sine function of space along a particular direction or orientation, e.g., windowed by a 2-dimensional Gaussian to remove sharp edges which otherwise introduce high spatial frequency intrusions. As FIGS. 5-8 show, each Gabor patch may have a respective orientation, where, after a first displayed value of the at least two graphical elements, each Gabor patch orientation may be rotated a specified amount with respect to an immediately previous Gabor patch. In other embodiments, other background patches may be used as desired.

Note that the embodiment illustrated in FIGS. 4-8 (and 9, described below) is but one example of the exercise, and that other, more complex, embodiments are contemplated, as described below in detail.

In 306, the participant may be required to respond to the displayed values. For example, following the exemplary embodiment of FIGS. 4-8, where a series of numbers were presented in temporal sequence, the participant may be required to input or otherwise indicate the numeric sequence, e.g., via a keyboard coupled to the computing device, although any other means may be used as desired. In other words, requiring the participant to respond to the displayed values may include requiring the participant to indicate the sequence of the displayed values. As will be described in detail below, other embodiments of the exercise may use other types of graphical elements (besides simple numbers), and may require correspondingly different responses from the participant.

In 308, a determination may be made as to whether the participant responded correctly. For example, following the embodiment of FIGS. 4-8, a determination may be made as to whether the participant correctly indicated the numeric sequence presented respectively in FIGS. 5-8. In preferred embodiments, the method may include audibly and/or graphically indicating whether the participant responded correctly. In embodiments where the participant's response includes a plurality of selections, indicating whether the participant responded correctly may include indicating whether the participant's selection is correct for each selection, e.g., for each selection, an indicative sound, such as a “ding” or “thunk” (and/or a graphical indication) may be played indicating whether that selection were correct or incorrect, respectively. In some embodiments, points may be awarded (in the case of a correct response and/or selection). Of course, any other type of indication may be used as desired. For example, in embodiment where a trial includes multiple selections, a first sound, e.g., a wind sound, may be played when the participant makes a correct selection, and a second sound, e.g., a chime sound, may be played when the participant has made all selections in the trial correctly.

Following the embodiment of FIGS. 4-8, FIG. 9 is an exemplary screenshot displaying the participant's response 902, i.e., the numeric sequence entered by the participant, 7125, the presented sequence 904, also 7125, and an indication of the correctness/incorrectness of the response 906, in this case, an indication that the participant responded correctly—specifically, the word CORRECT. As FIG. 9 also shows, in this embodiment, instructions are provided for initiating the next trial in the exercise, e.g., the next visual presentation of a sequence.

In some embodiments, each response of the participant may be recorded. Similarly, in some embodiments, the method may include recording whether the participant responded correctly. For example, the responses and/or their correctness/incorrectness may be stored in a memory medium of the computing device, or coupled to the computing device.

In 310, the stimulus intensity, e.g., duration, may then be modified based on the above determining. Of course, as mentioned above, the stimulus intensity may be any adjustable attribute of the graphical elements and/or their presentation, and so modifying the stimulus intensity may include modifying any of these adjustable attributes as desired. Modifying the stimulus intensity based on said determining preferably includes adjusting the stimulus intensity for the visually presenting based on whether the participant responded correctly.

In one embodiment, the adjusting may be performed using a maximum likelihood procedure, such as, for example, a QUEST (quick estimation by sequential testing) threshold procedure, and/or a ZEST (zippy estimation by sequential testing) threshold procedure, e.g., a single-stair maximum likelihood procedure, as described below in more detail.

In one embodiment, adjusting the stimulus intensity may include decreasing the duration if the participant responds correctly, and increasing the duration if the participant responds incorrectly. Thus, for example, in one embodiment, the duration may be set initially at 500 ms, and may adapt based on performance. In one modification scheme, after a correct response the duration may be multiplied by 0.8, and after an incorrect response, divided by 0.8. The inter-stimulus interval may be fixed at 200 ms for every trial. The results of this scheme are summarized thusly:

Initial trial: <500 ms>-<200 ms>-<500 ms>-<200 ms>-<500 ms>

After correct: <400 ms>-<200 ms>-<400 ms>-<200 ms>-<400 ms>

After incorrect: <625 ms>-<200 ms>-<625 ms>-<200 ms>-<625 ms>

In some embodiments, the duration may have minimum and maximum values, e.g., a minimum of 40 ms, and a maximum of 1000 ms. Of course, other modification schemes (and other ISI values) may be used as desired.

In 312, the visually presenting, requiring, determining, and modifying may be repeated one or more times in an iterative manner to improve the participant's cognition. For example, the repetitions may be performed over a plurality of sessions, e.g., over days, weeks, or even months, e.g., for a specified number of times per day, and for a specified number of days.

The above described visually presenting, requiring, determining, and modifying may compose performing a trial in the exercise. In preferred embodiments, the repeating may include performing a plurality of trials under each of a plurality of conditions, where each condition specifies one or more attributes of the at least two graphical elements or their presentation.

In some embodiments, over the course of performing the plurality of trials, the stimulus intensity may be adjusted (i.e., the modifying of 310) to approach and substantially maintain a specified success rate for the participant. For example, the stimulus intensity may be adjusted to approach and substantially maintain a specified success rate for the participant uses a single stair maximum likelihood procedure. Moreover, in further embodiments, the adjusting the stimulus intensity to approach and substantially maintain a specified success rate for the participant may be performed for each of the plurality of conditions, as will be discussed in more detail below.

### FURTHER EXEMPLARY EMBODIMENTS

The below describes exemplary embodiments of more complex versions of the Eye Movement exercise, although it should be noted that various aspects of the embodiments described herein may be utilized with respect to any other embodiments of the exercise as desired.

In one embodiment, visually presenting the temporal sequence of at least two of the graphical elements may include visually presenting a first plurality of the graphical elements in a spatial arrangement in the visual field, where each graphical element in the first plurality of graphical elements has a respective position, and where the at least two graphical elements are included in the first plurality of graphical elements. In other words, prior to displaying the sequence of (at least two) graphical elements, the set of graphical elements from which the sequence of graphical elements are taken may be presented in the visual field in a specified arrangement. The particular arrangements used may be specified by the conditions under which trials are performed.

For example, where the visual field has a fixation point in the center of the visual field (see, e.g., FIG. 4), each of the first plurality of the graphical elements may be displayed within a specified range of the fixation point. The distance of displayed graphical elements from the center of the visual field (fixation point) may be referred to as the “eccentricity” of the stimuli. In one embodiment, the specified range may include a first range, comprising a first minimum distance from the fixation point, and a first maximum distance from the fixation point, or a second range, comprising a second minimum distance from the fixation point, and a second maximum distance from the fixation point, where the second minimum distance is greater than the first minimum distance, and where the second maximum distance is greater than the second maximum distance. In some embodiments, the second minimum distance may be greater than or equal to the first maximum distance. Thus, the first plurality of graphical elements may be displayed in a rough annulus about the fixation point in the visual field, where the conditions under which the trials are performed may specify the inner and outer radii of the annulus, e.g., constraints on the eccentricity of the stimuli. Note that since the sequence of graphical elements in a trial are selected (e.g., randomly) from the first plurality of graphical elements, thus constraining their respective positions to those in the annulus, the larger the annulus, the more eye movement by the participant is required to view each graphical element in succession, and thus, the more difficult the trial. Thus, for example, in some embodiments, each of the plurality conditions may specify the range of distances from a fixation point in the visual field for the first plurality of graphical elements. These ranges may be specified as radii from the center, e.g., Rmin1: 3 cm, Rmax1: 5 cm, Rmin2: 5 cm, Rmax2: 7 cm; or via angular subtense, e.g., Rmin1: 10 degs, Rmax1: 15 degs, Rmin2: 15 degs, Rmax2: 20 degs.

Other aspects of the sequence of graphical elements or their presentation may include: the number of graphical elements in the first plurality of graphical elements, the number of graphical elements in the presented sequence of the at least two graphical elements, whether the durations of the visually presenting overlap, complexity of the graphical elements, and/or visual emphasis, i.e., distinguishability of the graphical elements from a background displayed in the visual field, among others.

Thus, over the course of the exercise, the conditions may range from easier to more difficult. For example, the conditions may include combinations of various categories of attributes of the graphical elements or their presentation. Examples of the categories include: gap/overlap categories, where in the gap category, the current stimulus disappears before the next one is presented, and in the overlap category, the current stimulus remains on for a short period of time (e.g. 0.25 s) after the next one is presented; stimulus complexity categories, where, in the easy categories, stimuli may be easy (e.g. data strings embedded in Gabor patch stimuli that rotate orthogonally on each presentation), while in more advanced stimulus categories, the stimuli may be objects (e.g. faces, pictures, cards); emphasis level categories, where at easier levels, the presented values may be easily distinguishable from the background, and at harder levels, the values may be less distinct from the background information; serial or sequence size categories, where a beginning level may start with an easier serial size (e.g. 2 items), and at higher levels, the size may expand to 3 and 4; and stimuli distance categories, where each level may have an associated annular distance (and possibly thickness) for display of the first plurality of graphical elements (which also applies to the presented sequences, since they are from this first plurality of graphical elements). However, these various conditions, categories, levels, and progressions are meant to be exemplary only, and are not intended to limit the exercise to any particular set of conditions, categories, levels, or progressions.

Note that displaying the first plurality of graphical elements does not include displaying their values, but rather, establishes spatial positions for any graphical elements selected for the visually presented sequences. Moreover, in some embodiments, when, or prior to, the visual presentation of the at least two graphical elements (and their values), the first plurality of graphical elements may be removed from view. In other words, the first plurality of graphical elements may disappear from the visual field before the particular sequence of graphical elements (and their values) are visually presented.

Card Match

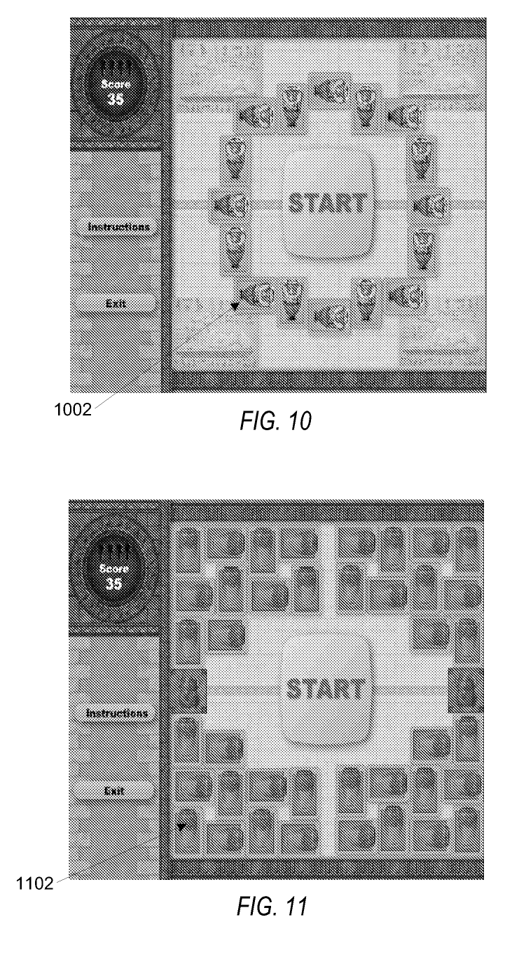

FIGS. 10-15 are directed to embodiments of the exercise where the multiple graphical elements are playing cards, e.g., where the value of each graphical element includes the playing card's suit and rank or value, e.g., a 10 of hearts, although any other types of cards may be used as desired. In this version of the exercise, referred to herein as Card Match, after a sequence of playing cards are presented, the participant is required to match each (remembered) card in the sequence to a respective card displayed elsewhere on the screen, as will be discussed in more detail below.

In this version of the exercise, visually presenting the first plurality of the graphical elements in a spatial arrangement in the visual field may include visually presenting a first plurality of the playing cards face down (meaning with their values not displayed) at respective positions in the visual field, i.e., the values of the graphical elements are not displayed. Similarly, the at least two graphical elements are at least two playing cards, and visually presenting the temporal sequence of at least two of the graphical elements includes revealing the respective values of the at least two playing cards in sequence, where for each of the at least two playing cards, the value is displayed for the duration, then the playing card is turned face down. In some embodiments, revealing the respective values of the at least two playing cards in sequence may include displaying the values of the at least two playing cards in sequence for respective durations, separated by a specified inter-stimulus interval (ISI). In various embodiments, the ISI may be held constant, e.g., at 200 ms, as mentioned above, or may be adjusted, e.g., as part of the duration, or as specified by the various conditions under which trials are performed. Note, for example, that negative values for the ISI result in overlap between the durations or presentation times of the values, where, for example, each succeeding value is presented before the previous value is removed from view.

In one embodiment, visually presenting the temporal sequence of at least two of the graphical elements may include highlighting the at least two cards, where after turning the at least two playing cards face down, the highlighting is maintained. This may reduce confusion in the participant regarding which of the first plurality of cards were sequenced. In some embodiments, prior to the revealing of values of the sequence of playing cards, the first plurality of playing cards may be removed from view. In other words, just before the sequence is visually presented, the first plurality of graphical elements, in this case, the first plurality of playing cards, may disappear.

As described above, in one embodiment, the respective positions of the visually presented graphical elements (in this case, playing cards) may be determined randomly, e.g., where the position of the first graphical element of the at least two graphical elements is randomly selected, and has a first azimuth, and where each subsequent graphical element of the at least two graphical elements is positioned at a random distance from the center of the visual field, and an azimuth differing from that of the previous graphical element by a respective randomly determined angle. The respective angle may be a randomly determined angle between approximately 90 and approximately 180 degrees, or between approximately −90 and approximately −180 degrees. Mathematically expressed, the angle may be +/−(90+random(90)) degrees. As noted above, a primary purpose of the different positions of the graphical elements is to force the participant to move his or her eyes substantially to focus on each graphical element. However, other schemes for distributing the graphical elements in the visual field may be used as desired.

FIG. 10 is an exemplary screenshot of a GUI for such an embodiment using playing cards. As FIG. 10 shows, the first plurality of playing cards is displayed in a ring 1002 around the center or fixation point of the visual display. In this particular case, the distance range of the playing cards from the center of the visual display is fairly small, and the first plurality of playing cards includes a fairly small number of playing cards, e.g., 16, although other numbers may be used as desired.

As FIG. 10 indicates, in some embodiments, besides the visual field, additional GUI elements may be provided, e.g., for indicating various aspects of the participant's progress or status with respect to the exercise or task, invoking help, etc. For example, the GUI may include one or more of: a score indicator that indicates the participant's current score in the task or exercise, as shown in the upper left corner of FIG. 10, a Start button (or functional equivalent), whereby the participant may invoke the next trial in the exercise, an instruction button (or equivalent), whereby the participant may invoke instructions or other helpful information for the task, and an exit button for exiting the exercise, among others.

Note that any other GUI elements may be included as desired. For example, in some embodiments, the GUI may include one or more of: a time remaining indicator that provides an indication of how much time remains in the current task, session, or exercise, a threshold field that displays stimulus threshold information, such as the current threshold value and a best threshold value, where a threshold indicates or is the value of the adjustable stimulus intensity, that results in a specified performance level, i.e., success rate, for the participant, as will be explained below in more detail. However, it should be noted that these particular GUI elements are meant to be exemplary only, and are not intended to limit the GUIs contemplated to any particular form, function, or appearance.

FIG. 11 is another exemplary screenshot of the GUI for an embodiment using playing cards. As FIG. 11 shows, in this case, the first plurality of playing cards is displayed in a larger ring 1102 around the center or fixation point of the visual display, where the distance range of the playing cards from the center of the visual display is greater than that of FIG. 10, and where the first plurality of playing cards includes a greater number of playing cards, e.g., 40, although, of course, other numbers may be used as desired. Thus, the trial illustrated in FIG. 11 may be more difficult than the trial illustrated in FIG. 10. In some embodiments, in a first level of the exercise, trials may be performed using the smaller ring/plurality of playing cards, such as that shown in FIG. 10, and in a second level of the exercise, trials may be performed using the greater ring/plurality of playing cards, such as that shown in FIG. 11, although it should be noted that other levels, rings, and pluralities may be used as desired.

In some embodiments, a second plurality of playing cards may be displayed face up, where the second plurality of playing cards includes playing cards with the same values as the at least two playing cards, and one or more distracter cards with different values. As indicated above, in this embodiments, requiring the participant to respond to the displayed values includes requiring the participant to indicate matches between each of the at least two playing cards and respective ones of the second plurality of playing cards. In other words, once the values of the visually presented sequence of playing cards have been displayed or revealed (and then flipped, hidden, or otherwise removed from view), the second plurality of playing cards are displayed, and the participant may successively indicate matches between each playing card in the sequence and one of the second plurality of playing cards. For example, in one embodiment, requiring the participant to indicate matches between each of the at least two playing cards and respective ones of the second plurality of playing cards may include: for each playing card of the at least two playing cards: receiving input from the participant selecting one of the at least two playing cards, and receiving input from the participant selecting a playing card from the second plurality of playing cards as a match for the selected one of the at least two playing cards, e.g., by clicking on each card with a mouse.

In some embodiments, if a card is incorrectly matched, the incorrectness of the selection may be indicated, e.g., with a “thunk” sound, the (e.g., six) cards in the middle of the screen may disappear, the trial may be terminated, and the start button may appear. If all three cards are correctly matched, the correctness of the selection may be indicated, e.g., with a “chime” sound, bonus points may be awarded, the (e.g., six) cards in the middle of the screen may disappear, and the start button may appear.

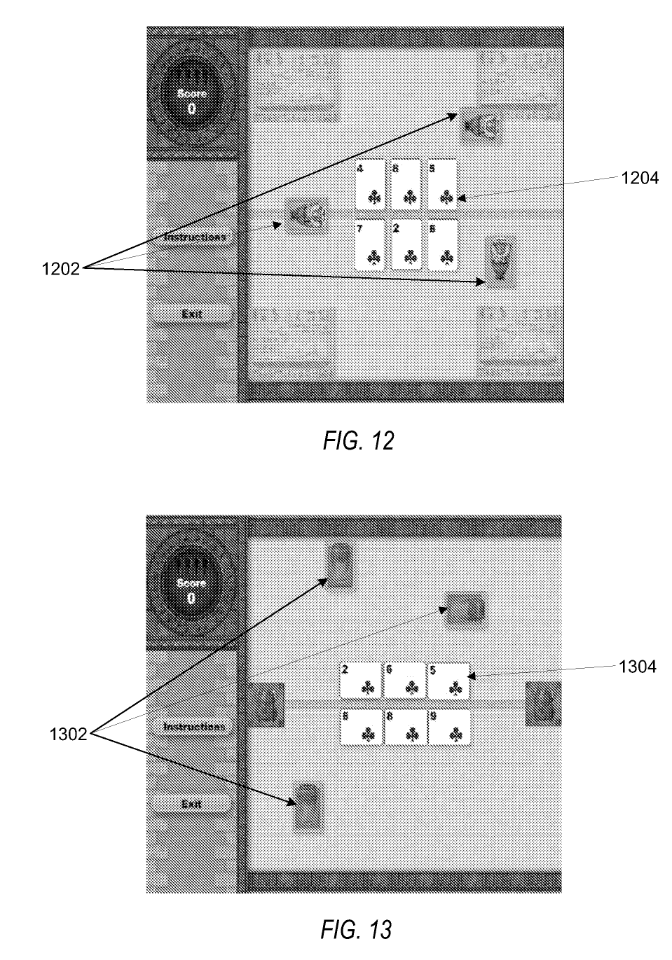

FIGS. 12 and 13 illustrate exemplary successor screenshots of the GUIs of FIGS. 10 and 11, respectively. As each of these figures illustrates, in these embodiments, the first plurality of playing cards has been removed from view, the values of the sequence of playing cards have been displayed, then flipped back face down (1202 of FIG. 12, and 1302 of FIG. 13), and the second plurality of playing cards, in both of these cases, 6 playing cards, have been displayed in the center of the visual field (1204 of FIG. 12, and 1304 of FIG. 13). Thus, in both cases, the second plurality of playing cards includes playing cards with the values of the sequenced cards, plus three additional distracter cards. As described above, the participant may then indicate matches between the cards by successively selecting one of the playing cards in the sequence (1202/1302), then selecting one of the playing cards (1204/1304) displayed in the middle of the visual field as a match, until all the sequenced cards have been matched. In preferred embodiments, the method may further include removing correctly matched playing cards from the visual field. Thus, as the participant successfully performs trials in the exercise, the first plurality of playing cards may be reduced in number until depleted. In various embodiments, at this point, the exercise may continue with a new first plurality of playing cards, e.g., at the same or a higher level, or the exercise may end, at least for the current session.

Note that in embodiments directed to playing cards, such as described above, the conditions under which trials are performed may specify further aspects of the graphical elements or their presentation. For example, in some embodiments, each of the plurality conditions may further specify whether the at least two playing cards are of the same suit, and/or whether the suit of the at least two playing cards can change for each trial.

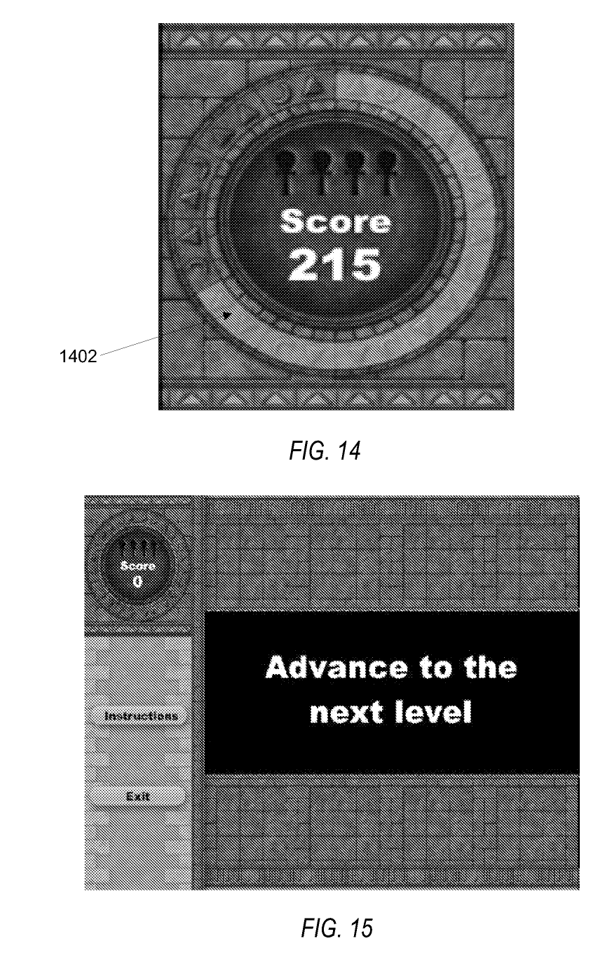

In some embodiments, bonus points may be awarded and indicated, e.g., for when the participant successfully performs a trial, e.g., matches all the sequenced cards correctly, or, as another example, when the participant successfully performs a specified number of trials consecutively, e.g., 5 times in a row. Thus, in some embodiments, the GUI may also include a bonus meter (or equivalent), which may indicate such bonus awards. Note that this may be in addition to the awarding of bonus points. One embodiment of such a bonus indicator is included in the score display of FIGS. 10-13, where, for example, each time the participant successfully performs a trial, the ring around the numeric score is incrementally filled in, e.g., a “gold piece” is added to the ring, as illustrated in FIG. 14. This may be performed in addition to awarding bonus points, which may be reflected in the score indicator. Of course, any other kind of bonus indicator may be used as desired, such as a bar meter, filled in bonus stars, etc. In some embodiments, bonuses may instead or also be indicated by flashing graphical elements, graphical animations, playing music, and so forth, as desired.

As noted above, the exercise may include performing trials in a plurality of levels. For example, in one exemplary embodiment of the Card Match version of the exercise, there may be two levels based on the relative closeness of the cards to the central fixation point and the number of suits. For example, in level 1, all cards in all trials may be of the same suit, and the cards may be distributed closer to a central fixation point (see, e.g., FIGS. 10 and 12); in level 2, all cards in given trials may be of the same suit, but the suit can change between trials, and the cards may be distributed further from a central fixation point (see, e.g., FIGS. 11 and 13).

In one embodiment, the participant may be able to choose to start Card Match at level 1, e.g., by choosing an “Easy” button, or at level 2, e.g., by choosing a “Hard” button, in an introductory screen. If Card Match is started at level 1, the participant may advance to level 2 after having filled in the gold circle around the score (e.g., 12 correct trials), as illustrated in FIG. 14. FIG. 15 is an exemplary screenshot instructing the participant to begin the next level. Note that in this embodiment, the score has been reset to zero for the next level.

It should be noted that the Card Match version of the exercise described herein is meant to be exemplary, and such matching versions of the exercise may be performed using any other types of graphical elements and values desired, e.g., tokens, coins, or other elements with values based on colors, shapes, pictures, etc.

Word Finder

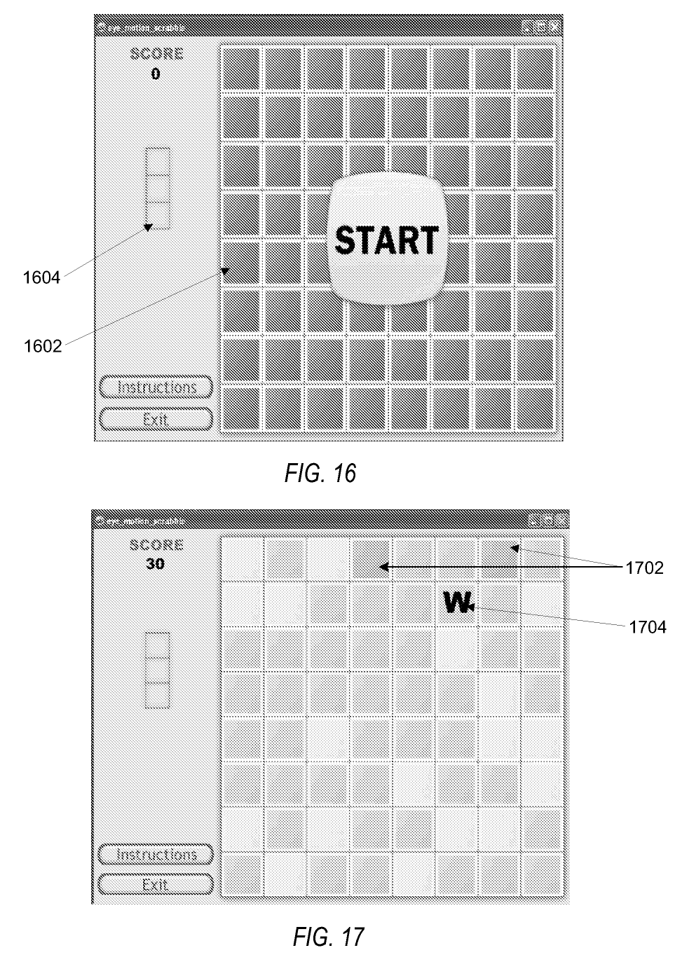

FIGS. 16-20 are directed to embodiments of the exercise where the multiple graphical elements are letter tiles, e.g., where the value of each graphical element is a letter. In this version of the exercise, referred to herein as Word Finder, a sequence of letters representing a scrambled word are presented, where, as with the Card Match version described above, the values of the tiles are shown for a respective specified duration. The participant then attempts to select the tiles in an order that correctly spells the scrambled word, and the stimulus intensity, e.g., the duration or presentation time, of the sequence is modified based on the participant's response, as will be discussed in more detail below.

In this version of the exercise, visually presenting the first plurality of the graphical elements in a spatial arrangement in the visual field may include visually presenting a first plurality of the tiles face down (meaning with their values not displayed) at respective positions in the visual field, i.e., the values of the graphical elements are not displayed. Similarly, the at least two graphical elements are at least two tiles, and visually presenting the temporal sequence of at least two of the graphical elements includes revealing the respective values of the at least two tiles in sequence, where for each of the at least two tiles, the value is displayed for the duration, then the tile is turned face down, i.e., the value ceases to be displayed. Note, however, that in this version of the exercise, the respective letters of the at least two tiles in sequence are a scrambled word. In other words, the sequence of letters (temporarily) presented form a scrambled word, which the participant is expected to unscramble.

As with the Card Match version, in some embodiments, revealing the respective letters of the at least two tiles in sequence may include displaying the letters of the at least two tiles in sequence for respective durations, separated by a specified inter-stimulus interval (ISI), which in various embodiments, may be held constant, e.g., at 200 ms, as mentioned above, or may be adjusted, e.g., as part of the duration, or as specified by the various conditions under which trials are performed.

In one embodiment, the values (e.g., letters) may be assigned to the visually presented graphical elements (e.g., tiles) dynamically. For example, first, the letters of the word may be scrambled, and then each letter (of the scrambled word) may be associated with and presented on the selected tiles, i.e., on the sequence of tiles being visually presented. In other words, in some embodiments, values may not be assigned to graphical elements until the graphical elements are visually presented in sequence.

Note that in some embodiments, the graphical elements of the visually presented sequence may already have respective positions, e.g., as part of the first plurality of graphical elements. In these embodiments, the graphical elements may be selected for inclusion in the sequence by randomly determining the positions, as described above, then selecting the graphical elements (from the first plurality of graphical elements) that are closest to these positions.

In preferred embodiments, visually presenting the temporal sequence of at least two of the graphical elements may include highlighting the at least two tiles, where after turning the at least two tiles face down, the highlighting is maintained, thereby indicating to the participant which of the first plurality of tiles were sequenced. In some embodiments, prior to the revealing of letters of the sequence of tiles, the first plurality of tiles may be removed from view, as described above (and shown in FIGS. 12 and 13) with respect to the Card Match version of the exercise.

FIG. 16 is an exemplary screenshot of a GUI for such an embodiment using tiles. As shown, in this embodiment the GUI includes a grid of tiles 1602 displayed in a visual field of the GUI, e.g., constituting the first plurality of graphical elements corresponding to the spatial arrangement of playing cards described above with respect to the Card Match version of the exercise. As FIG. 16 also shows, the GUI also includes a score indicator, instruction button, and exit button, so labeled, as well as a start button for initiating a trial. As may be seen, the GUI of FIG. 16 also includes a letter or word display 1604, for displaying letters of the tiles selected by the participant. Note that the letter or word display 1604 preferably has the same length as that of the visually presented sequence of letters.

FIG. 17 is an exemplary screenshot of a GUI after a number of trials in the Word Finder version of the exercise have been performed, as evidenced by the various tiles missing from the original grid (of FIG. 16). As FIG. 17 indicates, two tiles 1702 of a three-tile sequence have already been highlighted (here shown in a slightly different color than the other tiles), had their respective letters revealed, and then been turned face down (i.e., display of the letters ceased), and the letter of the third tile in the sequence 1704 is currently displayed, in this case, a “W”. As noted above, the sequence of letters shown or revealed form a scrambled word. In preferred embodiments, the first letter of the (unscrambled) word may always be presented as a capital letter, regardless of when or where in the presented sequence it appears. Thus, in the embodiment of FIG. 17, the participant knows (or should realize) that the unscrambled word begins with the letter w.

Once the sequence of FIG. 17 has been visually presented and display of the letters ceased, the sequenced tiles may remain highlighted, as mentioned above. Requiring the participant to respond to the displayed values may then include requiring the participant to indicate the at least two tiles in a sequence that correctly spells the scrambled word. In other words, the participant may then click on the (possibly highlighted) sequenced tiles in an order that correctly spells the originally scrambled word. Note that in this particular example, the unscrambled word is “Wax”.

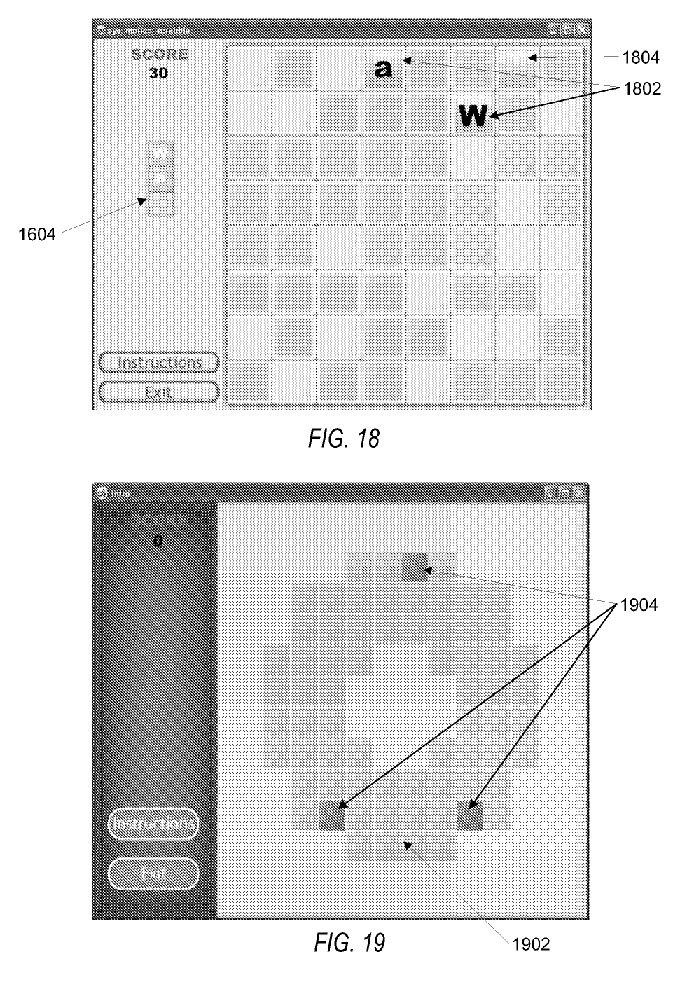

FIG. 18 is an exemplary screenshot illustrating the participant's selection of the tiles to spell the unscrambled word. As indicated, the participant has correctly selected the “W” and “a” tiles 1802 in succession, and so it only remains for the participant to select the third tile 1804 to correctly spell the word. Note that in preferred embodiments, the letters of the word may be displayed as the participant successfully indicates the at least two tiles in a sequence that correctly spells the scrambled word. Thus, as FIG. 18 shows, the letters “W” and “a” are displayed appropriately in the letter or word display 1604. Thus, once the participant selects the third tile (“x”), the completed unscrambled word will be displayed. Note that in the embodiment illustrated in FIG. 18, as the participant selects each tile in the sequence, the tile's letter may be displayed. In some embodiments, the method may include removing correctly matched tiles from the visual field, thus, depleting the first plurality of tiles as the participant successfully performs trials.

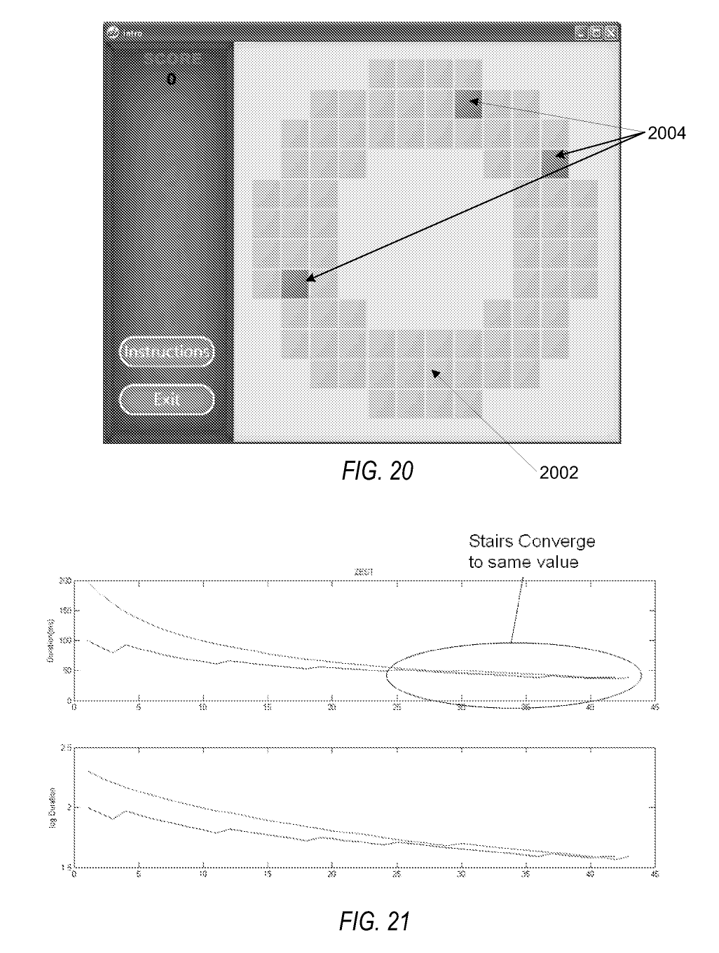

Similar to the Card Match version of the exercise, in some embodiments, rather than displaying the first plurality of tiles in a rectangular grid, as shown in FIGS. 16-18, the tiles may be displayed in annuli (i.e., circular grids) of various sizes, as specified by the various conditions under which trials are performed. FIGS. 19 and 20 illustrate this idea.

FIG. 19 is an exemplary screenshot of a GUI in which the first plurality of tiles is displayed in a ring or circular grid 1902 around the center or fixation point of the visual display. In this particular case, the distance range of the tiles from the center of the visual display is fairly small, and the first plurality of tiles includes a fairly small number of tiles, e.g., 68, although other numbers may be used as desired. Note that the sequenced tiles 1904 are shown highlighted.

FIG. 20 is an exemplary screenshot of a GUI in which the first plurality of tiles is displayed in a larger ring 2002 around the center or fixation point of the visual display as compared to that of FIG. 19, i.e., the distance range of the tiles from the center of the visual display is greater than that of FIG. 19, and where the first plurality of tiles includes a greater number of tiles, e.g., 80, although, of course, other numbers may be used as desired. Thus, the trial illustrated in FIG. 20 may be more difficult than the trial illustrated in FIG. 19. As with the Card Match version of the exercise, in some embodiments, in a first level of the exercise, trials may be performed using the smaller ring/plurality of tiles, such as that shown in FIG. 19, and in a second level of the exercise, trials may be performed using the greater ring/plurality of tiles, such as that shown in FIG. 20, although it should be noted that other levels, rings, and pluralities may be used as desired. In some embodiments, participants can choose to start at level 1 by selecting an “Easy” button, or at level 2 by selecting a “Hard” button. If the exercise is started at level 1, participants may advance to level 2 after they have cleared all the tiles in level 1.

Thus, in one specific exemplary embodiment, a trial may proceed as follows: a sequence of letters that form a three-letter word may be presented randomly one after the other on a circular grid of letter tiles, where each letter is presented briefly on a blank tile before that tile again becomes blank. The tile on which the letter appeared may be highlighted. Additionally, the presentation time for each letter may be the same but may change based on performance. The participant is expected to unscramble and identify the three-letter word. The participant may click on one of the highlighted tiles on which the letters appeared, the letter beneath that tile may be revealed and may be displayed under the score, e.g., in the letter or word display, and a “pop” sound may be played. This may be repeated until all three letters are revealed. If the word is correctly identified, a “ding” sound may play, points may be awarded, the word may be highlighted or displayed under the score, and the start button may appear. If the word is incorrectly identified, a “thunk” sound may play, the word may be removed from under the score, and the start button may appear.

As mentioned above, in preferred embodiments, the modification or adjustment of the stimulus intensity, e.g., the duration of each visual presentation of the value of each graphical element in the sequence, may be performed repeatedly over the course of the exercise based on the correctness or incorrectness of the participant's responses. The adjustments may generally be made to increase the difficulty of the stimulus when the participant answers correctly (e.g., shortening the duration or presentation time), and to decrease the difficulty of the stimulus when the participant answers incorrectly (e.g., increasing the duration or presentation time). Moreover, the adjustments may be made such that a specified level of performance, i.e., level of success, is approached and substantially maintained during performance of the exercise. For example, based on the participant's responses, the stimulus intensity may be adjusted to substantially achieve and maintain a specified success rate, e.g., 85% for the participant, although other rates may be used as desired.

As also mentioned above, in preferred embodiments, the adjustments may be made using a maximum likelihood procedure, such as a QUEST (quick estimation by sequential testing) threshold procedure, or a ZEST (zippy estimation by sequential testing) threshold procedure, described below, such procedures being well-known in the art of stimulus threshold determination. In some embodiments, these adjustments (e.g., using ZEST) may be determined on a per condition basis. In other words, for each condition (used in each task), the sequences may be presented (and adjusted) in accordance with a maximum likelihood procedure (e.g., ZEST) applied to trials under that condition.

Moreover, as described below, the repeating may also include performing threshold assessments in conjunction with, or as part of, the exercise. In other words, the method of FIG. 3 may include assessing the participant's performance a plurality of times during the repeating. Additionally, the assessing the participant's performance a plurality of times may be performed according to the maximum likelihood procedure, e.g., using a 2-stair maximum likelihood procedure. A description of such threshold determination/assessment is provided below.

Threshold Determination/Assessment

As indicated above, stimulus intensity is an adjustable attribute of a presented stimulus whereby a trial in the exercise may be made more or less difficult. For example, in one embodiment, the stimulus intensity may be the duration of the stimulus presentation, i.e., the presentation time (possibly including the ISI), although other attributes of the stimulus may be used as desired. The term “threshold” refers to the value of the stimulus intensity at which the participant achieves a specified level of success, e.g., 0.9, corresponding to a 90% success rate. Thus, any other attribute or combination of attributes may be used as desired, the term stimulus intensity being intended to refer to any such adjustable attributes.

Exercise based assessments (i.e., threshold determination) are designed to assess a participant's threshold with respect to stimuli on a given exercise, and can be used to adjust stimulus presentation to (substantially) achieve and maintain a desired success rate for the participant, e.g., with respect to a particular exercise, task, or condition. As will be described below, such threshold determination may also be used to assess or determine a pre-training threshold that can then be used to calibrate the program to an individual's capabilities on various exercises, as well as serve as a baseline measure for assessing the participant's performance periodically during an exercise. Such assessment may also serve as a baseline measure to which post-training thresholds can be compared. Comparison of pre-training to post-training thresholds may be used to determine the gains made as a function of training with the cognition enhancement exercise or tasks described herein.

As noted above, there are various approaches whereby such thresholds may be assessed or determined, such as, for example, the well known QUEST (Quick Estimation by Sequential Testing) threshold method, which is an adaptive psychometric procedure for use in psychophysical experiments, or a related method, referred to as the ZEST (Zippy Estimation by Sequential Testing) procedure or method, among others, although it should be noted that such methods have not heretofore been utilized in cognition enhancement training exercises using eye movement, as described herein.

The ZEST procedure is a maximum-likelihood strategy to estimate a subject's threshold in a psychophysical experiment based on a psychometric function that describes the probability a stimulus is detected as a function of the stimulus intensity. For example, consider a cumulative Gaussian psychometric function, F(x−T), for a 4-alternative-forced-choice (afc) task with a 5% lapsing rate, with proportion correct (ranging from 0-1) plotted against intensity of the stimulus (ranging from 0-5). As used herein, the term intensity (with respect to stimuli) refers to the value of the adaptive dimension variable being presented to the participant at any particular trial in a particular exercise. In other words, the intensity value is that parameter regarding the exercise stimuli that may be adjusted or adapted, e.g., to make a trial more or less difficult. For example, in preferred embodiments of the Eye Movement exercise, the intensity value is the duration or presentation time (e.g., in milliseconds) of the presented values of the sequence of graphical elements (possibly including the ISI). The threshold is defined to be the mean of the Gaussian distribution for a specified success rate—e.g., a value yielding some specified success rate, e.g., 60%, which corresponds to an intensity of 2.

The method may make some assumptions about the psychophysics:
1. The psychometric function has the same shape, except a shift along the stimulus intensity axis to indicate different threshold value.
2. The threshold value does not change from trial to trial.
3. Individual trials are statistically independent.

The primary idea of the ZEST procedure is as follows: given a prior probability density function (P.D.F.) centered around the best threshold guess, x, this P.D.F. is adjusted after each trial by one of two likelihood functions, which are the probability functions that the subject will respond “yes” or “no” to the stimulus at intensity as a function of threshold. Since the psychometric function has a constant shape and is of the form F(x−T), fixing the intensity x and treating threshold T as the independent variable, the “yes” likelihood, p=F(−(T−x)), is thus the mirror image of the psychometric function about the threshold, and the “no” likelihood function is then simply 1−p.

The P.D.F. is updated using Bayes' rule, where the posterior P.D.F. is obtained by multiplying the prior P.D.F. by the likelihood function corresponding to the subject's response to the trial's stimulus intensity. The mean of the updated (or posterior) P.D.F. is then used as the new threshold estimate and the test is repeated with the new estimate until the posterior P.D.F. satisfies a confidence interval criteria (e.g. standard deviation of posterior P.D.F.<predetermined value) or a maximum number of trials is reached.

In one example of the ZEST procedure, a single trial of a 4-afc experiment is performed, with x=2.5 (intensity) as the initial threshold guess. If the subject responds correctly, the next trial is placed at the mean of the corresponding posterior P.D.F., ˜x=2.3; if the response is incorrect, the next trial is placed at the mean of the corresponding P.D.F., ˜x=2.65.

Thus, in some embodiments, a single stair ZEST procedure such as that described above may be used to adjust the intensity of the stimuli for the Eye Movement exercise during training. In contrast, in some embodiments, particularly with respect to the periodic assessments during the exercise (as opposed to the “per response” stimulus adjustment) a 2-stair ZEST procedure may be employed, where two independent tracks with starting values, preferably encompassing the true threshold, each running its own ZEST procedure, are randomly interleaved in the threshold seeking procedure. In addition to their individual termination criterion, the difference between the two stairs may also be required to be within a specified range, e.g., the two stairs may be constrained to be a predetermined distance apart. An exemplary implementation of this approach is described below with respect to the eye movement threshold assessment.

As used herein, the parameters required for ZEST may include the mean of the prior P.D.F. (threshold estimate), the standard deviation of the prior P.D.F. (spread of threshold distribution), the standard deviation of the cumulative Gaussian distribution (slope of psychometric function), the maximum number of trials to run, and a confidence level and interval. Additionally, in one embodiment, the trial-by-trial data saved for analysis may include: the track used, the stimulus intensity presented, the subject's response, the mean of posterior P.D.F., and the standard deviation of the posterior P.D.F., as well as any other data deemed necessary or useful in determining and/or assessing the participant's threshold.

Thus, in preferred embodiments, a maximum likelihood procedure, such as a ZEST procedure, may be used to adjust the stimulus intensity (e.g., duration) of the presented sequences during training (e.g., via a single stair ZEST procedure per condition), and may also be used for assessment purposes at periodic stages of the exercise (e.g., via a dual stair ZEST procedure, describe below). In one embodiment, such assessment may occur at specified points during the exercise, e.g., at 0% (i.e., prior to beginning), 25%, 50%, 75%, and 100% (i.e., after completion of the exercise) of the exercise. An example of such assessment is now described.

A primary purpose of the Eye Movement threshold assessment is to determine the smallest stimulus intensity, e.g., duration, in an eye movement task that a person can respond correctly to above a statistical threshold. The Eye Movement assessment may be similar to the Eye Movement exercise with respect to visual presentation, where the differences between the assessment and the exercise lie (at least primarily) in the movement or progression through the task and the data that are obtained from this movement for the assessment. The procedure is designed to obtain a threshold, which is a statistical rather than an exact quantity. In one embodiment, for the purposes of this exercise, the threshold may be defined as the smallest stimulus intensity, e.g., duration of stimulus duration or presentation time (in milliseconds) for each value (possibly including the ISI), at which the participant will fail to respond correctly a specified percentage, e.g., 69%, 85%, 90%, etc., of all trials for the task. In a preferred embodiment, being a computer based task, the Eye Movement assessment may use the ZEST procedure to progress or move through the task, adjust the stimulus intensity (e.g., duration) for the sequence, and determine the statistical threshold.

As noted above, many aspects of the Eye Movement assessment may generally be similar, or possible even identical, to the Eye Movement exercise task with respect to visual presentation. However, some aspects of the Eye Movement exercise may not be necessary in the Eye Movement assessment. For example, with regard to the GUI, in some embodiments, GUI elements such as score indicator, bonus indicator, etc., may not be necessary, and so may be omitted. Features or assets that may remain the same may include the “ding”, “thunk”, and “chime” sounds (or equivalents) that play after a participant responds correctly or incorrectly. The assessment stimulus presentation may also be identical to the training version.

The following describes one embodiment of a 2-stair (dual track) approach for determining a psychophysical threshold for a participant, e.g., an aging adult, where the task is directed to perception of presented sequences, and where the stimulus intensity comprises the stimulus presentation time (possibly including the ISI), also referred to as duration, although other attributes may be used as desired, the duration being exemplary only. Initially, first and second tracks may be initialized with respective durations based on an initial anticipated threshold, where the initial anticipated threshold is an initial estimate or guess of a duration corresponding to a specified performance level of the participant, e.g., a stimulus duration at which the participant fails to respond correctly some specified percentage of the time, e.g., 69%. For example, in one embodiment, the first track may be initialized to a first duration that is below the initial anticipated threshold, e.g., preferably just slightly below the initial anticipated threshold, and the second track may be initialized to a second duration that is (e.g., slightly) above the initial anticipated threshold. Thus, the initial durations of the two tracks may straddle the initial anticipated threshold.

The method elements 302-308 of FIG. 3 may be performed, as described above, where the sequence of graphical element values are presented in accordance with the duration (or more generally, the stimulus intensity) of a specified one of either the first track or the second track. In other words, one of the tracks may be selected or otherwise determined, and the stimuli (values) may be presented with a duration of or specified by the selected track. Thus, in preferred embodiments, the initial anticipated threshold, the first duration, the second duration, and the (to be determined) threshold each is or includes a respective stimulus duration or presentation time (possibly including the ISI). As also described above, the participant may be required to respond to the sequence of values (306), and a determination may be made as to whether the participant responded correctly (308).

The duration (or more generally, the stimulus intensity) of the specified track may then be adjusted or modified, based on the participant's response (see, e.g., 310). For example, the duration of the track may be modified in accordance with a maximum likelihood procedure, such as QUEST or ZEST, as noted above. In one embodiment, for each track, modifying the duration of the specified track based on the participant's response may include increasing the duration if the participant responds incorrectly, and decreasing the duration if the participant responds correctly. Thus, for each assessment trial (in a given track), the duration for the sequence presentation for that trial may be determined by the performance of the previous trial for that track. In other words, the participant's response to the stimulus determines that track's next stimulus duration via the maximum likelihood method.

Similar to 312 of FIG. 3, the visually presenting, requiring, determining, and modifying or adjusting (of the duration, or more generally, the stimulus intensity), may be repeated one or more times in an iterative manner, but in this case, the repeating is performed to determine respective final durations for the first track and the second track. For example, in one embodiment, trials in the first track and the second track may be performed in an alternating manner, or, alternatively, trials may be performed in the first track and the second track randomly with equal probability. Thus, over numerous trials, the number of trials performed in each track should be equal, or at least substantially equal. In preferred embodiments, the presenting, requiring, determining, and modifying, may be repeated until the durations of the first track and the second track have converged to values within a specified confidence interval, and where the values are within a specified distance from each other, or, until a specified number of trials have been conducted for each track. In other words, the repetition may continue until either some maximum number of trials has been performed, or until convergence conditions for the tracks have been met, both singly, and together. For example, each track may be required converge to a respective duration value, and the convergent values for the two tracks may be required to be within some distance or interval of each other.

A threshold for the participant may then be determined based on the respective final durations for the first track and the second track, where the threshold is or specifies the stimulus duration or presentation time associated with the specified performance level of the participant. For example, as mentioned above, the determined threshold may specify the duration (i.e., the presentation time) at which the participant fails to respond correctly some specified percentage of the trials, e.g., 50%, 69%, etc., although it should be noted that any other percentage may be used as desired. In one embodiment, the threshold for the participant may be determined by averaging the respective final durations for the first track and the second track. More generally, the threshold for the participant may be determined by averaging the respective final stimulus intensity values for the first track and the second track.

Thus, in one embodiment, when making an assessment, the mean of two randomly interleaved Zests may be used with estimates made at a threshold level of 50% to make the estimate (which is standard for this type of task). When training, a single staircase ZEST procedure may used with a threshold level of 85%.

FIG. 21 illustrates an exemplary case where two tracks or “stairs” used in a ZEST threshold procedure are shown converging to a threshold value (in this case, duration) over a series of trials. Note that in the top graph, duration vs. trials is plotted in a linear manner, whereas the bottom graph provides the same information but is logarithmic on the duration (vertical) axis. As may be seen, after about 25 trials, the two tracks or stairs converge to a value at or near 50 ms, thus, the two tracks, initialized respectively to values above and below an initial estimate of the threshold, converge to an approximation of the participant's actual stimulus threshold for the exercise.

In some embodiments, the method may also include performing a plurality of practice trials, i.e., prior to performing the method elements described above. For example, in some embodiments, one or more practice sessions may be performed prior to the beginning of training to familiarize the participant with the nature and mechanisms of the exercise. For example, in one embodiment, before training begins, the participant may perform at least one practice session comprising a specified number of trials (e.g., 5) for each of one or more practice conditions. In some embodiments, the participant may be able to invoke such practice sessions at will during the exercise, e.g., to re-familiarize the participant with the task at hand.

In some embodiments, additional trials, referred to as “eureka” trials, may be performed periodically, e.g., every 20 trials or so, comprising non-ZEST trials that are easier than the current threshold estimate—e.g. using durations that are twice the threshold. These easier trials may serve to encourage the participant to continue the exercise, and improve or maintain the participant's morale.

Thus, embodiments of the Eye Movement exercise described herein may operate to improve a participant's cognition, including, for example, frequency of saccade, minimal fixation duration (or other stimulus intensity) required to extract information from the visual scene, overall speed and accuracy of visual processing, attention, and/or memory, among others. It should be noted that the particular exercise disclosed herein is meant to be exemplary, and that other repetition-based cognitive training exercises using visual stimuli with multiple stimulus sets may be used as desired, possibly in combination. In other words, the Eye Movement exercise described herein is but one example of a cognitive training exercise using a computing system to present visual stimuli to a participant, record the participant's responses, and modify some aspect of the visual stimuli based on these responses, where these method elements are repeated in an iterative manner using multiple sets of stimuli to improve the cognitive ability of the participant, e.g., to process visual information. Note particularly that such cognitive training using a variety of such visual stimulus-based exercises, possibly in a coordinated manner, is contemplated.

Those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

We claim:

1. A method for enhancing cognition in a participant, utilizing a computing device to present visual stimuli for training, and to record responses from the participant, the method comprising:
providing multiple graphical elements, wherein each graphical element has a value, and wherein the multiple graphical elements are available for visual presentation to the participant;
visually presenting a temporal sequence of at least two of the graphical elements at a specified stimulus intensity, including displaying the value of each of the at least two graphical elements at a respective position in a visual field for a specified duration, then ceasing to display the value;
requiring the participant to respond to the displayed values;
determining whether the participant responded correctly;
modifying the stimulus intensity based on said determining; and
repeating said visually presenting, said requiring, said determining, and said modifying one or more times in an iterative manner to improve the participant's cognition.

2. The method of claim 1, wherein said visually presenting, said requiring, and said determining compose performing a trial, and wherein said repeating comprises performing a plurality of trials under each of a plurality of conditions, wherein each condition specifies one or more attributes of the at least two graphical elements or their presentation.

3. The method of claim 2, wherein the respective positions of the at least two graphical elements are determined randomly, wherein a first graphical element of the at least two graphical elements has a first position with a first azimuth, and wherein each subsequent graphical element of the at least two graphical elements has an azimuth differing from that of the previous graphical element by a respective angle.

4. The method of claim 3, wherein the respective angle is a randomly determined angle of:
between approximately 90 and approximately 180 degrees; or
between approximately −90 and approximately −180 degrees.

5. The method of claim 2, wherein said requiring the participant to respond to the displayed values comprises:
requiring the participant to indicate the sequence of the displayed values.

6. The method of claim 2, wherein the displayed values comprise one or more of:
objects;
numbers;
letters;
colors; and/or
shapes.

7. The method of claim 2, wherein each value is displayed in a respective Gabor patch in the visual field.

8. The method of claim 7, wherein each Gabor patch has a respective orientation, and wherein, after a first displayed value of the at least two graphical elements, each Gabor patch orientation is rotated a specified amount with respect to an immediately previous Gabor patch.

9. The method of claim 2, wherein said visually presenting the temporal sequence of at least two of the graphical elements comprises:
visually presenting a first plurality of the graphical elements in a spatial arrangement in the visual field, wherein each graphical element in the first plurality of graphical elements has a respective position;
wherein the at least two graphical elements are comprised in the first plurality of graphical elements.

10. The method of claim 9, wherein the visual field has a fixation point in the center of the visual field, and wherein said visually presenting a first plurality of the graphical elements in a spatial arrangement in the visual field comprises:
displaying each of the first plurality of the graphical elements within a specified range of the fixation point.

11. The method of claim 10, wherein the specified range comprises one of:
a first range, comprising a first minimum distance from the fixation point, and a first maximum distance from the fixation point; and
a second range, comprising a second minimum distance from the fixation point, and a second maximum distance from the fixation point;
wherein the second minimum distance is greater than the first minimum distance; and
wherein the second maximum distance is greater than the second maximum distance.

12. The method of claim 11, wherein the second minimum distance is greater than or equal to the first maximum distance.

13. The method of claim 2, wherein each of the plurality conditions specifies one or more of:
range of distances from a fixation point in the visual field for the first plurality of graphical elements;
number of graphical elements in the first plurality of graphical elements;
number of graphical elements in the presented sequence of the at least two graphical elements;
whether the durations of the visually presenting overlap;
complexity of the graphical elements; and
distinguishability of the graphical elements from a background displayed in the visual field.

14. The method of claim 13,
wherein each graphical element represents a respective playing card;
wherein said visually presenting the first plurality of the graphical elements in a spatial arrangement in the visual field comprises visually presenting a first plurality of the playing cards face down at respective positions in the visual field;
wherein the at least two graphical elements comprise at least two playing cards, and wherein said visually presenting the temporal sequence of at least two of the graphical elements comprises:
revealing the respective values of the at least two playing cards in sequence, wherein for each of the at least two playing cards, the value is displayed for the duration, then the playing card is turned face down;
the method further comprising:
displaying a second plurality of playing cards face up, wherein the second plurality of playing cards includes playing cards with the same values as the at least two playing cards, and one or more distracter cards with different values;
wherein said requiring the participant to respond to the displayed values comprises requiring the participant to indicate matches between each of the at least two playing cards and respective ones of the second plurality of playing cards.

15. The method of claim 14, wherein said requiring the participant to indicate matches between each of the at least two playing cards and respective ones of the second plurality of playing cards comprises:
for each playing card of the at least two playing cards:
receiving input from the participant selecting one of the at least two playing cards; and
receiving input from the participant selecting a playing card from the second plurality of playing cards as a match for the selected one of the at least two playing cards.

16. The method of claim 14, wherein said wherein said visually presenting the temporal sequence of at least two of the graphical elements further comprises:
highlighting the at least two cards, wherein after said turning the at least two playing cards face down, said highlighting is maintained.

17. The method of claim 14, wherein each of the plurality conditions further specifies one or more of:
whether the at least two playing cards are of the same suit; and
whether the suit of the at least two playing cards can change for each trial.

18. The method of claim 14, further comprising:
removing correctly matched playing cards from the visual field.

19. The method of claim 14, further comprising:
removing the first plurality of playing cards from view prior to said revealing.

20. The method of claim 14, wherein said revealing the respective values of the at least two playing cards in sequence comprises:
displaying the values of the at least two playing cards in sequence for respective durations, separated by a specified inter-stimulus interval (ISI).

21. The method of claim 13,
wherein each graphical element comprises a tile, and wherein the value of each graphical element is a letter;
wherein said visually presenting the first plurality of the graphical elements in a spatial arrangement in the visual field comprises visually presenting a first plurality of the tiles face down at respective positions in the visual field;
wherein the at least two graphical elements comprise at least two tiles, and wherein said visually presenting the temporal sequence of at least two of the graphical elements comprises:
revealing the respective letters of the at least two tiles in sequence, wherein for each of the at least two tiles, the letter is displayed for the duration, then the tile is turned face down, and wherein the respective letters of the at least two tiles in sequence are a scrambled word; and
wherein said requiring the participant to respond to the displayed values comprises requiring the participant to indicate the at least two tiles in a sequence that correctly spells the scrambled word.

22. The method of claim 21, wherein said wherein said visually presenting the temporal sequence of at least two of the graphical elements further comprises:
highlighting the at least two tiles, wherein after said turning the at least two tile face down, said highlighting is maintained.

23. The method of claim 21, further comprising:
removing correctly matched tiles from the visual field.

24. The method of claim 21, further comprising:
removing the first plurality of tiles from view prior to said revealing.

25. The method of claim 21, wherein said revealing the respective letters of the at least two tiles in sequence comprises:
displaying the letters of the at least two tiles in sequence for respective durations, separated by a specified inter-stimulus interval (ISI).

26. The method of claim 20, wherein a letter in the scrambled word that is the first letter of the word is capitalized.

27. The method of claim 20, further comprising:
displaying the letters of the word as the participant successfully indicates the at least two tiles in a sequence that correctly spells the scrambled word.

28. The method of claim 2, wherein said modifying comprises:
adjusting the stimulus intensity for said visually presenting based on whether the participant responded correctly;
wherein said adjusting is performed using a maximum likelihood procedure.

29. The method as recited in claim 28, wherein the maximum likelihood procedure comprises one or more of:
a QUEST (quick estimation by sequential testing) threshold procedure; or
a ZEST (zippy estimation by sequential testing) threshold procedure.

30. The method of claim 28, wherein said adjusting the stimulus intensity comprises:
adjusting the stimulus intensity to approach and substantially maintain a specified success rate for the participant.

31. The method of claim 30, wherein said adjusting the stimulus intensity to approach and substantially maintain a specified success rate for the participant is performed for each of the plurality of conditions.

32. The method of claim 30, wherein said adjusting the stimulus intensity to approach and substantially maintain a specified success rate for the participant uses a single stair maximum likelihood procedure.

33. The method of claim 28, wherein said repeating comprises:
assessing the participant's performance a plurality of times during said repeating.

34. The method of claim 33, wherein said assessing the participant's performance a plurality of times is performed according to the maximum likelihood procedure.

35. The method of claim 34, wherein said assessing the participant's performance a plurality of times is performed using a 2-stair maximum likelihood procedure.

36. The method of claim 28, wherein the stimulus intensity comprises the duration of the stimulus, wherein said adjusting the stimulus intensity comprises:
if the participant responds correctly, decreasing the duration; and
if the participant responds incorrectly, increasing the duration

37. The method of claim 28, wherein the stimulus intensity comprises one or more of:
eccentricity of the respective positions of the least two graphical elements in the visual field;
number of graphical elements in the temporal sequence;
appearance of the graphical elements; and/or
visual emphasis of the graphical elements.

38. The method of claim 2, further comprising:
recording each response of the participant; and/or
recording whether the participant responded correctly.

39. The method of claim 2, further comprising:
indicating whether the participant responded correctly, wherein said indicating is performed audibly and/or graphically.

40. The method of claim 39, wherein the participant's response comprises a plurality of selections, and wherein said indicating whether the participant responded correctly comprises:
for each selection, indicating whether the participant's selection is correct.

41. The method of claim 2, further comprising:
performing trials in one or more practice sessions under each of one or more conditions.

42. The method of claim 2, wherein said repeating occurs a specified number of times each day, for a specified number of days.

43. A computer-readable memory medium that stores program instructions for enhancing cognition in a participant, utilizing a computing device to present visual stimuli for training, and to record responses from the participant, wherein the program instructions are executable by a processor to perform:
providing multiple graphical elements, wherein each graphical element has a value, and wherein the multiple graphical elements are available for visual presentation to the participant;
visually presenting a temporal sequence of at least two of the graphical elements at a specified stimulus intensity, including displaying the value of each of the at least two graphical elements at a respective position in a visual field for a specified duration, then ceasing to display the value;
requiring the participant to respond to the displayed values;
determining whether the participant responded correctly;
modifying the duration based on said determining; and
repeating said visually presenting, said requiring, said determining, and said modifying one or more times in an iterative manner to improve the participant's cognition.
